(19) United States
(12) Patent Application Publication
(10) Pub. No.: US 2021/0394307 A1
(43) Pub. Date: Dec. 23, 2021

(54) METHOD OF JOINING WORKPIECES USING HIGH SPEED LASER WELDING AND PRODUCTS FORMED USING THE METHOD

(71) Applicant: Ford Global Technologies, LLC, Dearborn, MI (US)

(72) Inventor: Jo Ann Marie Clarke, Plymouth, MI (US)

(73) Assignee: Ford Global Technologies, LLC, Dearborn, MI (US)

(21) Appl. No.: 16/909,859

(22) Filed: Jun. 23, 2020

(51) Int. Cl. B23K 26/244; B23K 26/32; B60J 5/04

(52) U.S. Cl. CPC B23K 26/244; B23K 26/32; B60J 5/0468; B23K 2101/006; B60J 5/0402; B60J 5/0416; B60J 5/0483

(57) ABSTRACT

A method of laser welding a first aluminum workpiece and a second aluminum workpiece arranged to form a lap joint includes forming a laser weld between the first aluminum workpiece and the second aluminum workpiece and forming a lap through weld joint using a weld speed equal to or greater than 10 meters per minute. The laser weld has less than 10% area fraction keyhole voids, for example, less than 5% area fraction keyhole voids and the lap through weld joint can have a flange length of less than 10 mm. The first aluminum workpiece can be an inner workpiece of a halo assembly of a vehicle door, the second aluminum workpiece can be a channel workpiece of the halo assembly and laser welding the inner workpiece to the channel workpiece forms the halo assembly without the use of mechanical fasteners, thereby decreasing weight and costs of the halo assembly.

### FIELD

The present disclosure relates to laser welding of alloys and particularly to laser welding of aluminum alloys.

### BACKGROUND

The statements in this section merely provide background information related to the present disclosure and may not constitute prior art.

During laser welding of workpieces (e.g., aluminum or aluminum alloy workpieces), a high energy density laser beam forms a molten weld pool with a vapor “keyhole” within the molten weld pool. As the laser beam travels in the weld direction, molten metal flows into and fills the volume previously occupied by the keyhole and a sound laser weld is formed. However, in some materials such as aluminum alloys, the keyhole can become unstable during the laser welding process and exhibit collapse-reform-collapse cycles during formation of the laser weld. Also, collapsing of the keyhole can result in issues such as internal voids, spatter, surface irregularities, surface undercut, and/or weld drop-through for full penetration welds.

These challenges with laser welding and keyhole stability, among other issues related to laser welding, are addressed by the present disclosure.

### SUMMARY

In one form of the present disclosure, a method of laser welding aluminum alloys includes arranging a first aluminum workpiece and a second aluminum workpiece to form a lap joint, and forming a laser weld between the first aluminum workpiece and the second aluminum workpiece and forming a “lap through weld joint” using a weld speed equal to or greater than 10 meters per minute. In some variations, the laser weld has less than 10% area fraction keyhole voids. In at least one variation, the laser weld has less than 5% area fraction keyhole voids.

In some variations, the first aluminum workpiece comprises a flange and the second aluminum workpiece comprises another flange overlapping the flange of the first aluminum workpiece and forming the lap joint. In such variations, the lap through weld joint can have a flange length of less than 10 mm. For example, in some variations the first aluminum workpiece is an inner workpiece of a vehicle door, the second aluminum workpiece is a channel workpiece of the vehicle door, and forming the laser weld between the inner workpiece and the channel workpiece forms a halo assembly for a vehicle door with a laser welded flange having a flange length of less than 10 mm. In at least one variation, the lap through weld joint formed by the flange of the inner workpiece and the another flange of the channel workpiece is free of joining by rivets. In some variations, the lap through weld joint formed by the flange of the inner workpiece and the another flange of the channel workpiece is free of joining by self-piercing rivets and/or resistance spot welds.

In another form of the present disclosure, a method of forming a vehicle component includes forming a lap joint with a first flange of a first AA5XXX aluminum alloy workpiece extending across a second flange of a second AA5XXX aluminum alloy workpiece, and laser welding the first flange of the first AA5XXX aluminum alloy workpiece to the second flange of the second AA5XXX aluminum alloy workpiece and forming a lap through weld joint using a weld speed equal to or greater than 10 meters per minute. In some variations, the laser weld has less than 10% area fraction keyhole voids and the lap through weld joint is free of joining by self-piercing rivets. In at least one variation, the laser weld has less than 5% area fraction keyhole voids.

In some variations, the vehicle component is a halo assembly for a vehicle door. In such variations the halo assembly can be formed without rivets. For example, the halo assembly can be formed without self-piercing rivets or resistance spot welds.

In at least one variation, the lap through weld joint has a flange length less than or equal to 10 mm. In some variations, the lap through weld joint has a flange length less than or equal to 8 mm. In at least one variation, the lap through weld joint has a flange length less than or equal to 6 mm, for example less than or equal to 4 mm.

In still another form of the present disclosure, a method of manufacturing a vehicle door assembly includes assembling an inner workpiece with a first flange and a channel workpiece with a first flange such that the first flange of the inner workpiece extends across the first flange of the channel workpiece and forms a lap joint around a vehicle door window opening and laser welding the lap joint using a weld speed equal to or greater than 10 meters per minute and forming a lap through weld joint such that the inner workpiece and the channel workpiece are joined together free of mechanical fasteners and resistance spot welds. In some variations the method includes joining an outer workpiece to the inner workpiece and the channel workpiece and forming a vehicle door halo assembly.

In at least one variation, the inner workpiece and the channel workpiece are formed from one or more aluminum alloys and the lap through weld joint has a flange length less than or equal to 10 mm. For example, in at least one variation the lap through weld joint has a flange length less than or equal to 8 mm.

In some variations, the outer workpiece is joined to at least one of the inner workpiece and the glass channel workpiece by hemming the outer workpiece onto at least one of the inner workpiece and the glass channel workpiece.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of lap joint formed from a first workpiece extending across a second workpiece;

FIG. 1B is a perspective view of a lap through weld joint formed by a laser weld extending through the first workpiece and into the second workpiece in FIG. 1A;

FIG. 2 is transverse cross-sectional view of a keyhole formed during laser welding of a lap joint;

FIG. 3 is a transverse cross-sectional view of a laser weld in a lap through weld joint resulting from collapsing of the keyhole during laser welding;

FIG. 4A is a micrograph of a longitudinal cross-section of a laser weld in a lap through weld joint resulting from repeated collapsing of the keyhole during laser welding;

FIG. 4B is a micrograph of a transverse cross-section of the laser weld in the lap through weld joint in FIG. 4A;

FIG. 5A is a micrograph of a longitudinal cross-section of a laser weld in a lap through weld joint resulting severe drop-through during laser welding;

FIG. 5B is a micrograph of a transverse cross-section of the laser weld in the lap through weld joint in FIG. 5A;

FIG. 6 is a micrograph of a longitudinal cross-section of a laser weld in a lap through weld joint resulting from a stable keyhole during laser welding according to the teachings of the present disclosure;

FIG. 7 is a side view of a halo assembly for a vehicle door according to the teachings of the present disclosure;

FIG. 8 is a view of section 8-8 in FIG. 7;

FIG. 9 is a view of section 9-9 in FIG. 7;

FIG. 10 is a transverse cross-section of a component assembly according to the teachings of the present disclosure; and

FIG. 11 is a flow chart of a method for forming a laser welded lap through weld joint according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides an innovative method for laser welding of materials that exhibit keyhole instability problems. Particularly, the method provides keyhole stability during the laser welding process and thereby avoids keyhole collapse. The keyhole stability provided by the method according to the teachings of the present disclosure reduces or eliminates laser weld defects such as internal voids (also referred to herein as “keyhole voids”), spatter, surface irregularities, surface undercut, and severe drop-through. The method is particularly suited for magnesium containing aluminum alloys such as Aluminum Association designated AA5XXX aluminum alloys.

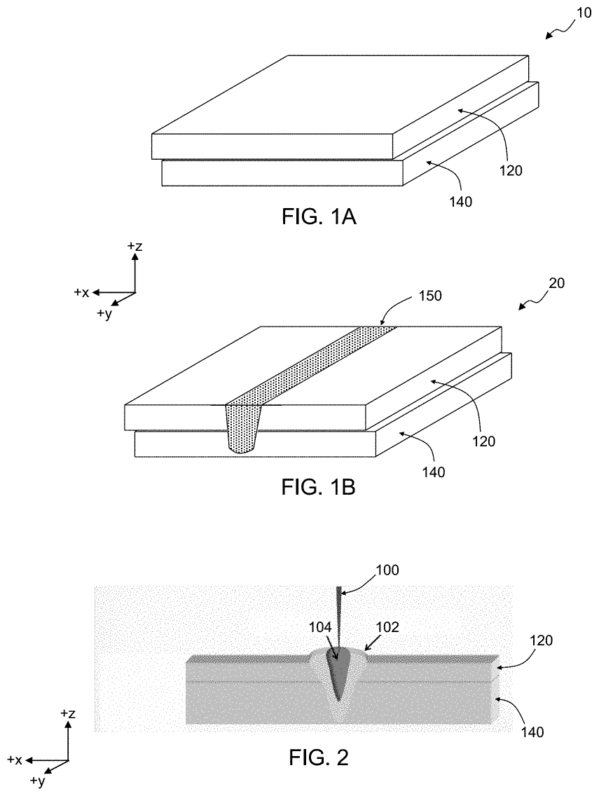

Referring to FIGS. 1A and 1B, a lap joint 10 formed from a first workpiece 120 extending across a second workpiece 140 is shown in FIG. 1A and a lap through weld joint 20 formed by laser welding the first workpiece 120 to the second workpiece 140 is shown in FIG. 1B. Particularly, the first workpiece 120 extending across (i.e., “overlapping”) the second workpiece 140 forms the lap joint 10 shown in FIG. 1A and a laser weld 150 extending “through” the first workpiece 120 into the second workpiece 140 forms the lap through weld joint 20 shown in FIG. 1B. In some variations, the first workpiece 120 and the second workpiece 140 are aluminum or aluminum alloy workpieces. For example, in at least one variation of the present disclosure the first and second workpieces 120, 140 (and other workpieces disclosed herein) are formed from one or more AA5XXX aluminum alloys. In other variations, one of the first and second workpieces 120, 140 is formed from an AA5XXX aluminum alloy and the other of the first and second workpieces 120, 140 is formed from an AA6XXX aluminum alloy. It should be understood that the phrase “AA5XXX aluminum alloy(s)” refers to wrought aluminum alloys with between 0.2 and 6.2 weight percent (wt. %) magnesium as the major alloying element and the phrase “AA6XXX aluminum alloy(s)”)” refers to wrought aluminum alloys with magnesium and silicon additions of about 1.0 wt. %.

Referring to FIG. 2, a laser beam 100 laser welding the first workpiece 120 to the second workpiece 140 and forming the lap through weld joint 20 (FIG. 1B) is shown. Particularly, the laser beam 100 forms a molten weld pool 102 extending through the first workpiece 120 and into the second workpiece 140. A vapor keyhole 104 (referred to herein simply as a “keyhole”) is formed and located generally in a central region of the molten weld pool 102. As the laser beam 100 travels along the weld direction (y direction shown in the figures), the molten weld pool 102 solidifies and forms the laser weld 150 (FIG. 1B) between the first workpiece 120 and the second workpiece 140.

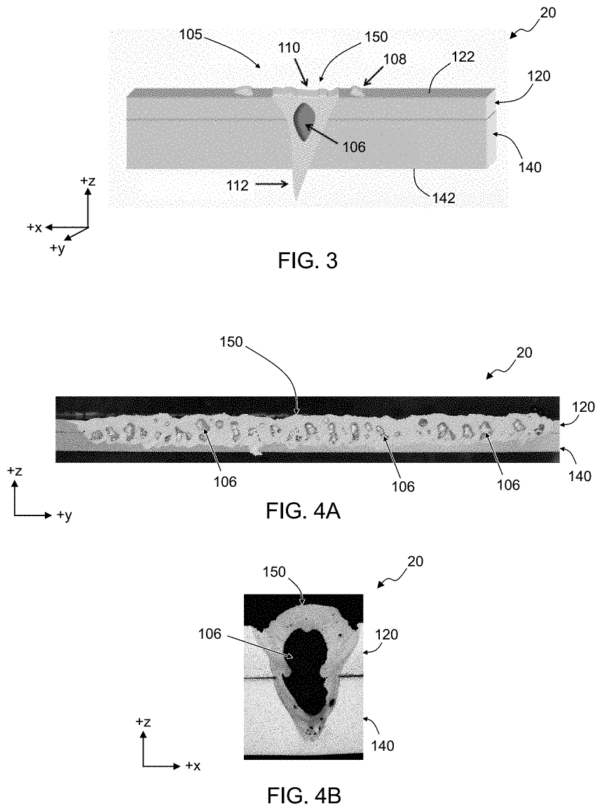

Referring to FIG. 3, a transverse section (x-z plane shown in the figures) of the lap through weld joint 20 and the laser weld 150 with defects 105 resulting from collapsing of the keyhole 104 during the laser welding process is shown. Particularly, the laser weld 105 has a large internal void 106, spatter 108 on an outer or upper surface 122 of the first workpiece 120, surface irregularities 110 present on an upper outer surface (+z direction) of the laser weld 150, and a severe drop-through 112 of the laser weld 150 extending from a bottom (−z direction) surface 142 of the second workpiece 140. As used herein, the phrase “large internal void” refers to a single internal void (also known as “encapsulated pore”) with an inner dimension equal to or greater than 30% of a minimum sheet thickness being welded and a maximum cumulative projected area of equal to or greater than 10%. Also, as used herein the phrase “severe drop-through” refers to a root convexity equal to or greater than 0.2 mm+30% of the bottom sheet (workpiece) thickness. It should be understood that limited drop-through of a laser weld can be acceptable, however severe drop-through of a laser weld can result in damage to components such as adjacent sheet metal, electrical wiring, interior components, trim, among others.

Referring to FIGS. 4A and 4B, a micrograph of a longitudinal section (y-z plane) and a transverse section (x-z plane), respectively, of a laser weld 150 of a lap through weld joint 20 having defects in the form of internal voids 106 is shown. The first workpiece 120 was formed from a 1.0 mm thick (z direction) sheet of the AA5754 aluminum alloy, the second workpiece 140 was formed from a 1.5 mm thick sheet of the AA5182 aluminum alloy, and the laser weld 150 was formed using a 10 kW laser and a weld speed of 6 meters (m) per minute (min). Also, the large internal void 106 shown in FIG. 4B has an area fraction of 35.0% and a maximum internal dimension equal to 1.74 mm. The nominal compositions for the AA5754 and AA5182 aluminum alloys are shown below in Table 1.

TABLE 1

| Element | AA5754 Alloy | AA5182 Alloy |
|---|---|---|
| Manganese (Mn) | 0.50 max | 0.20-0.50 |
| Iron (Fe) | 0.40 max | 0.35 max |
| Magnesium (Mg) | 2.60-3.60 | 4.0-5.0 |
| Silicon (Si) | 0.40 max | 0.20 max |
| Chromium (Cr) | 0.30 max | 0.10 max |
| Copper (Cu) | 00.10 max | 0.15 max |
| Mn + Cr | 0.10-0.60 | — |
| Other (each) | 0.05 max | 0.05 max |
| Others (total) | 0.15 max | 0.15 max |
| Titanium (Ti) | 0.15 max | 0.10 max |
| Zinc (Zn) | 0.20 max | 0.25 max |
| Aluminum (Al) | Balance | Balance |

As shown in FIG. 4A, the internal voids 106 extend along the length (y direction) of the laser weld 150 and are the result of continuous collapse of the keyhole during laser welding and formation of the lap through weld joint 20. It should be understood that such internal voids 106 are undesirable and can lead to a reduction in weld properties such as weld strength, weld ductility, among others.

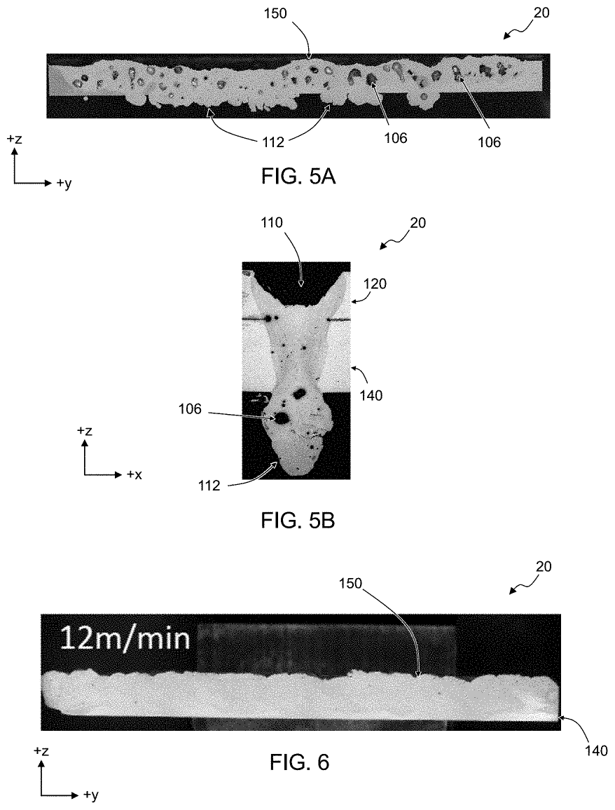

Referring to FIGS. 5A and 5B, a micrograph of a longitudinal section (y-z plane) and a transverse section (x-z plane), respectively, of a laser weld 150 of a lap through weld joint 20 having defects in the form of internal voids 106, a surface irregularity 110 in the form of a concavity, and severe drop-through 112 is shown. The first workpiece 120 was formed from a 1.0 mm thick sheet of the AA5754 aluminum alloy, the second workpiece 140 was formed from a 1.5 mm thick sheet of the AA5182 aluminum alloy, and the laser weld 150 was formed using a 10 kW laser and a weld speed of 3 m/min. Also, the surface irregularity 110 (concavity) shown in FIG. 5B has depth (−z direction) of 0.71 mm and the severe drop-through 112 extends 1.75 mm below (−z direction) the bottom surface (not labeled) of the second workpiece 140.

Referring to FIG. 6, a micrograph of a longitudinal section (y-z plane) of a laser weld 150 of a lap through weld joint 20 according to the teachings of the present disclosure is shown. The first workpiece 120 was formed from a 1.0 mm thick sheet of the AA5754 aluminum alloy, the second workpiece 140 was formed from a 1.5 mm thick sheet of the AA5182 aluminum alloy, and the laser weld 150 was formed using a 10 kW laser and a weld speed of 12 m/min. As shown in FIG. 6, the laser weld 150 is free or devoid of internal voids 106. Accordingly, increasing the weld speed by a factor of two (2), i.e., from 6 m/min to 12 m/min, stabilized the keyhole 104 such that defects did not form during laser welding of the lap through weld joint 20. In some variations of the present disclosure, the laser weld 150 has less than or equal to 10% area fraction keyhole voids, for example, less than or equal to 5% area fraction keyhole voids, less than or equal to 2.5% area fraction keyhole voids, or less than or equal to 1% area fraction keyhole voids.

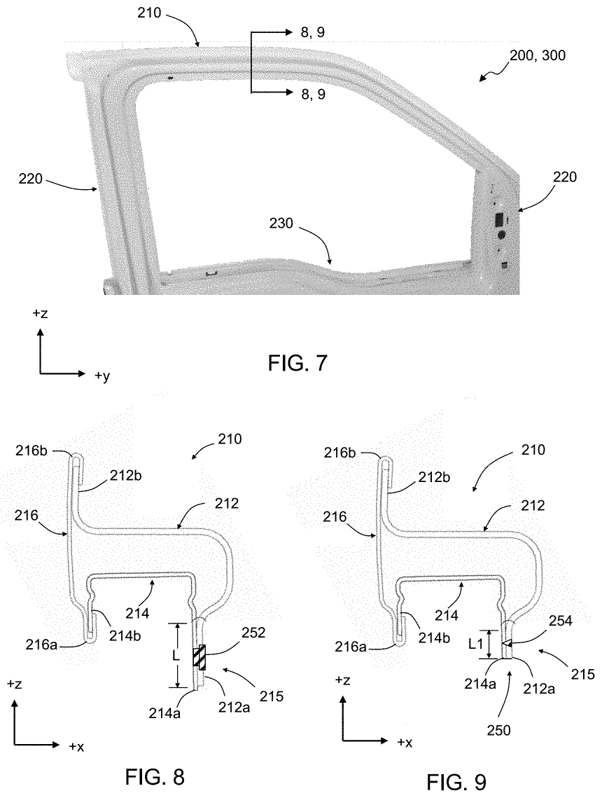

Referring to FIGS. 7 and 8, a side view of a halo assembly 200 for a vehicle door window (not shown) is shown in FIG. 7 and section 8-8 in FIG. 7 is shown in FIG. 8. The halo assembly 200 includes an upper (+z direction) portion 210, a pair of side (+/−x directions) portions 220, and a lower (−z direction) portion 230 that collectively provide or form a frame for the vehicle door window. At least the upper portion 210 of the halo assembly 200 includes an inner workpiece 212 (e.g., a sheet or panel), a channel workpiece 214, and an outer workpiece 216. Also, the inner workpiece 212 has a first inner flange 212a and a second inner flange 212b, the channel workpiece 214 has a first channel flange 214a and a second channel flange 214b, and the outer workpiece 216 has a first outer flange 216a and a second outer flange 216b. The first inner flange 212a extends across the first channel flange 214a to from a lap joint 215, the first outer flange 216a is hemmed over the second channel flange 214b, and the second outer flange 216b is hemmed over the second inner flange 212b.

Still referring to FIG. 8, the first inner flange 212a is joined or attached to the first channel flange 214a using steel self-piercing rivets (SPRs) or resistance spot welds 252. In some variations, using the SPRs or resistance spot welds 252 requires a flange length ‘L’ equal to or greater than 14 millimeters (mm) and both sides (i.e., the +x side and the −x side) of the lap joint 215 must be accessible during installation of the SPRs and/or forming of the resistance spot welds 252.

Referring now to FIGS. 7 and 9, a side view of a halo assembly 300 formed according to the teachings of the present disclosure is shown in FIG. 7 and section 9-9 in FIG. 7 is shown in FIG. 9. In some variations of the present disclosure, the halo assembly 300 is similar to the halo assembly 200, with like components have like reference numerals. However, the halo assembly 300 is different than the halo assembly 200 in that the first inner flange 212a is joined or attached to the first channel flange 214a with a laser weld 254 instead of SPRs and/or resistance spot welds 252. That is, a laser welding process with a welding speed greater than 10 m/min is used to form a desirable laser weld 254 between the first inner flange 212a and the first channel flange 214a thereby forming a lap through weld joint 250 shown in FIG. 9.

It should be understood that joining the first inner flange 212a to the first channel flange 214a with the laser weld 254 reduces or eliminates the need for SPRs or resistance spot welds to manufacture the halo assembly 300. Accordingly, the weight of the halo assembly 300 is reduced compared to the halo assembly 200. In addition, and as illustrated by comparing FIGS. 8 and 9, the flange length L1 of the lap joint 215 in FIG. 9 is less than the flange length L of the lap joint 215 in FIG. 8 such that additional weight savings and costs is provided compared to using SPRs and/or resistance spot welds. In some variations of the present disclosure, the flange length L1 of the lap through weld joint is less than or equal to 12 mm. For example, in some variations the flange length L1 is less than or equal to 10 mm and greater than or equal to 3 mm, less than or equal to 8 mm and greater than or equal to 3 mm, or less than or equal to mm and greater than or equal to 3 mm. Also, access to both sides (i.e., the +x side and the −x side) of the lap joint 215 in FIG. 9 is not required during laser welding of the first inner flange 212a to the first channel flange 214a, thereby increasing the flexibility of manufacturing the halo assembly 300.

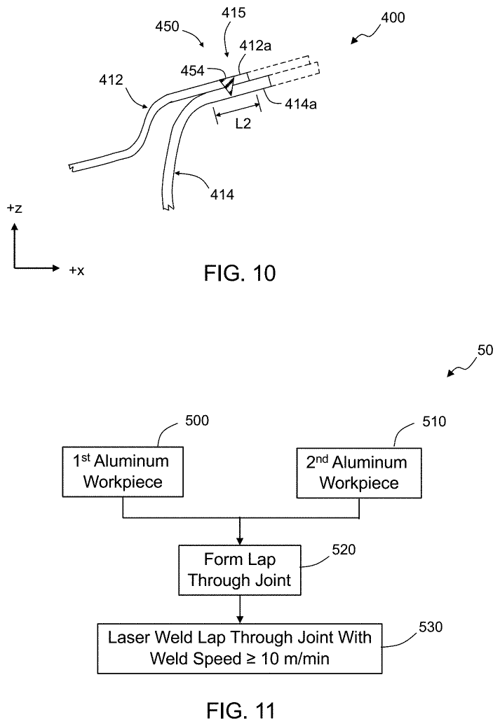

While FIGS. 7-9 show a halo assembly for a vehicle door window, it should be understood that the teachings of the present disclosure can be directed to the manufacture of other assemblies. Non-limiting examples of such other assemblies include reinforcements to inner panels of a closure assembly (e.g., reinforcements in a door panel), reinforcements to inner panels of a body sub-assembly (e.g., a B-pillar sub-assembly), reinforcements welded to structural components such a hydroformed tubes (e.g., reinforcements to a hydroformed roof rail and/or a hydroformed A-pillar), among others. Referring to FIG. 10, one example of such an assembly or reinforcement 400 includes a first flange 412a of a first aluminum alloy workpiece 412 extending across a second flange 414a of a second aluminum alloy workpiece 414 and forming a lap joint 415 with a flange length L2 is shown. In some variations, the first aluminum alloy workpiece 412 and the second aluminum alloy workpiece 414 are formed from different aluminum alloys, for example different AA5XXX alloys, an AA5XXX alloy and an AA6XXX alloy, different AA6XXX alloys, among others. In other variations, the first aluminum workpiece alloy 412 and the second aluminum alloy workpiece 414 are formed from the same aluminum alloy, for example an AA5XXX alloy, an AA6XXX alloy, among others.

Still referring to FIG. 10, a laser weld 454 formed according to the teachings of the present disclosure extends through the first flange 412a into the second flange 414a and forms a lap through weld joint 450. Shown with dotted lines and extending from the first flange 412a and second flange 414a are the additional flange lengths needed for joining the first flange 412a to the second flange 414a using one or more SPRs and/or a resistance spot welds. In some variations, the flange length L2 of the lap through weld joint 450 is less than or equal to 12 mm. For example, in some variations the flange length L2 is less than or equal to 10 mm and greater than or equal to 3 mm, less than or equal to 8 mm and greater than or equal to 3 mm, or less than or equal to 6 mm and greater than or equal to 3 mm. Also, access to both sides (i.e., the +z side and the −z side) of the lap joint 415 in FIG. 10 is not required during laser welding of the first flange 412a to the second flange 414a, thereby increasing the flexibility of manufacturing the assembly or reinforcement 400.

Referring now to FIG. 11, a flow chart for a method 50 of joining a pair of aluminum alloy (also referred to herein simply as “aluminum”) workpieces together is shown. The method 50 includes assembling a first aluminum workpiece at 500 and a second aluminum workpiece at 510 to form a lap joint at 520. The lap joint is laser welded at 530 using a weld speed equal to or greater than 10 m/min to form a lap through weld joint with generally no internal voids, splatter or drop-through. In some variations the laser is a 10 kW laser and the weld speed is between 10 m/min and 20 m/min, for example between 10 m/min and 15 m/min, between 10 m/min and 14 m/min, between 10 m/min and 13 m/min, between 10 m/min and 13 m/min, or between 10 m/min and 12 m/min.

As used herein, the phrase at least one of A, B, and C should be construed to mean a logical (A OR B OR C), using a non-exclusive logical OR, and should not be construed to mean “at least one of A, at least one of B, and at least one of C.”

Unless otherwise expressly indicated, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A method of laser welding a first aluminum workpiece and a second aluminum workpiece arranged to form a lap joint, the method comprising:
forming a laser weld between the first aluminum workpiece and the second aluminum workpiece and forming a lap through weld joint using a weld speed equal to or greater than 10 meters per minute, wherein the laser weld has less than 10% area fraction keyhole voids.

2. The method according to claim 1, wherein at least one of the first aluminum workpiece and the second aluminum workpiece is formed from a AA5XXX aluminum alloy.

3. The method according to claim 2, wherein the laser weld has less than 5% area fraction keyhole voids.

4. The method according to claim 2, wherein the first aluminum workpiece comprises a flange and the second aluminum workpiece comprises another flange overlapping the flange of the first aluminum workpiece and forming the lap through weld joint, wherein the lap through weld joint has a flange length of less than 10 mm.

5. The method according to claim 4, wherein the first aluminum workpiece is an inner workpiece of a halo assembly for a vehicle door and the second aluminum workpiece is a channel workpiece of the halo assembly.

6. The method according to claim 5, wherein forming the laser weld between the inner workpiece and the channel workpiece forms the halo assembly for the vehicle door.

7. The method according to claim 6, wherein the lap through weld joint formed by the flange of the inner workpiece and the another flange of the channel workpiece is free of joining by rivets.

8. The method according to claim 6, wherein the lap through weld joint formed by the flange of the inner workpiece and the another flange of the channel workpiece is free of joining by mechanical fasteners or resistance spot welds.

9. A method of laser welding a lap joint with a first flange extending across a second flange and at least one of the first flange and the second flange is an AA5XXX aluminum alloy, the method comprising:
laser welding the first flange to the second flange and forming a lap through weld joint using a weld speed equal to or greater than 10 meters per minute, wherein the laser weld has less than 10% area fraction keyhole voids and the lap through weld joint is free of joining by self-piercing rivets.

10. The method according to claim 9, wherein the vehicle component is a halo assembly for a vehicle door.

11. The method according to claim 10, wherein the halo assembly is formed without rivets.

12. The method according to claim 10, wherein the halo assembly is formed without self-piercing rivets or resistance spot welds.

13. The method according to claim 9, wherein the lap through weld joint has a flange length less than or equal to 10 mm.

14. The method according to claim 9, wherein the lap through weld joint has a flange length less than or equal to 8 mm.

15. The method according to claim 9, wherein the lap through weld joint has a flange length less than or equal to 6 mm.

16. The method according to claim 15, wherein the laser weld has less than 5% area fraction keyhole voids.

17. A method of manufacturing a vehicle door assembly, the method comprising:
assembling an inner workpiece with a first flange and a channel workpiece with a first flange such that the first flange of the inner workpiece extends across the first flange of the channel workpiece and forms a lap joint around a vehicle door window opening, wherein the inner workpiece and the channel workpiece are formed from one or more aluminum alloys;
laser welding the lap joint using a weld speed equal to or greater than 10 meters per minute and forming a lap through weld joint such that the inner workpiece and the channel workpiece are joined together free of mechanical fasteners and resistance spot welds; and
joining an outer workpiece to the inner workpiece and the channel workpiece and forming a vehicle door halo assembly.

18. The method according to claim 17, wherein the lap through weld joint has a flange length less than or equal to 10 mm.

19. The method according to claim 17, wherein the lap through weld joint has a flange length less than or equal to 8 mm.

20. The method according to claim 17, wherein the outer workpiece is joined to at least one of the inner workpiece and the channel workpiece by hemming the outer workpiece onto at least one of the inner workpiece and the channel workpiece.
